(19) United States
(12) Patent Application Publication
(10) Pub. No.: US 2013/0020809 A1
(43) Pub. Date: Jan. 24, 2013

(54) Pollution free electrical power generator

(71) Applicant: Arvind A. Daya, Fayetteville, GA (US)

(72) Inventor: Arvind A. Daya, Fayetteville, GA (US)

(21) Appl. No.: 13/136,012

(22) Filed: Jul. 20, 2011

(51) Int. Cl. H02K 7/10; F03B 13/14; F03G 7/10

(52) U.S. Cl. 290/1 C; 290/53; 74/DIG. 9

(57) ABSTRACT

Small AC power plant device comprises of three long parallel rigid arms. Primary function the rigid power arms is, ratcheting and reciprocating uniformly to turn a gearbox continuously, reduce torque and maintain rpm. Longer the rigid power arms, less torque required to turn the generator. One end of each rigid power arm is the attached with two sets of ratchet mechanisms on both sides along with one way clutch bearing on a common shaft. All three rigid power arms are attached to the same said shaft. Positive movement of the each rigid arm individually turns the said common shaft that is coupled to a gearbox whereby the generator continuously. Other end of the rigid power arms are attached to crankshaft or upright conveyer or ball screw assembly type of mechanism. This devices advantage is it maintains the required 50 Hz/60 Hz. and produces energy at zero pollution and low consumption.

### BACKGROUND OF THE INVENTION

1. Field of Invention

The present invention relates to a low speed, high torque rotary drive which is particularly useful in conjunction with gearbox driven generators such as wind power generators, where high torque can be reduced with this device that is applied to the gearbox whereby to generate power. This process can also be implemented on automobiles, homes, small business and at sea to produce clean electricity at a reduced cost for multiple applications

Another object of this device is it could be applied to any high torque required gearboxes applications. This invention relates to the generation of electricity and more particularly this invention relates to the method and apparatus used to generate electricity.

2. Related Art

The present invention remedies the disadvantages and shortcomings of the prior art by reducing the required torque to turn the gearbox whereby the generator to generate electricity. The statements in this section merely provide a global need and background information related to the present disclosure and may or may not constitute prior art.

The present invention is similar to the large MW windmill type design where large long blades crate a low speed high torque for the gearbox to increase the speed of the generator, during the period the wind is blowing. The windmill has two major downside, that is the blades turn at different speeds which causes two more major problems one is that gearbox get damaged at high speed and upkeep are high, the other issue is frequency cannot be maintained to produce AC power directly therefore power losses, the other downside is its cost because windmill are reaching heights as much 200 meter at tip of the blade and each blade as long as 100 meter.

The present decade has become a critical period for mankind globally and energy consumption continues to grow worldwide, as a result of population explosion, the decommission of Fukushima Daiichi Nuclear power plant due to the disaster along with Germany's decision to decommission all of Germany's nuclear plants permanently for safety, and there may be more to come, this has accelerated industrialization and economic growth and social development globally.

There is an increase public awareness of the social and environmental problem related to production and consumption of CO₂ related fuels.

Efficiency in the production of electricity is one of more critically important technical problems of the day. At a very time that the world's economy and the economies of the worlds industrial countries are becoming increasingly dependent on the consumption of electrical energy, there is a growing realization, the main source of this energy the earth's non-renewable fossil fuel reserves, will inevitably be exhausted and that in any event, the natural environment of the earth cannot readily assimilate the by-products of fossil fuel at much higher rates than it does at present without suffering unacceptable level of pollution whereby climate.

There is considerable agreement among scientists around the world that the byproduct of electricity is hydrogen as fuel will emerge as ultimate clean energy for the future. One of the raw material out of which hydrogen is derived, and covers 70% of the total surface area of the earth is water.

In the present invention all of these major issues are addressed and the outcome is excellent, further more this invention can be operated continuously and reliably at low cost almost anywhere.

### SUMMARY OF THE INVENTION

The object of the invention is to generate clean electrical energy by a new and improved method.

Another object is generate electricity that is AC power generated similar to the current method used, which is fossil fuel, direct engine driven generator sets. Except that, this present invention the generator is driven by its own power whereby gearbox and generator after an initial external start. Where AC electricity at 60 Hz or 50 Hz is generated by said generator, at constant speed required by design, power is recycled upon which only one third of the power is consumed by the motor in use, after initial start by external source. The balance of the power can be consumed elsewhere, at zero emissions.

The high-torque ratchet reciprocating and energy generating device comprises of three parallel long rigid power arms. These arms play a vital role in producing clean energy, and synchronize AC power production where there is no need for inverter from alternating current to DC to AC, for the rpm is maintained for designed frequency requirement.

The high degree of torque and the continues rotation of the gearbox is overcome by the ratchets mechanisms and one way clutch bearings housed on one end, each of the long rigid power arms. One end of each long power arm is attached to two or more ratchets and a sprag clutch or one way clutch bearings which is sandwich between said ratchets, on a common shaft whereby the said shaft is attached to turn a helical or a planetary type of a gearbox, to bear the high torque created by the gearbox to rotate the generator at the required rpm for 50 Hz or 60 Hz. The other ends of the long rigid power arms to a crankshaft type or conveyer type reciprocating device.

There are several methods of achieving a common goal of turning the high torque created by helical or planetary type gearbox to generate electricity.

On smaller generators, where one end of each rigid power arm on the generator side of the invention is fixed to two ratchets and a one way clutch bearing housed on a common shaft, each rigid power arm has two ratchet mechanism on each side of the rigid power arm and a one way clutch in the middle of the said arm, to turn the high torque created by the helical or planetary gearbox and generator.

To achieve the reciprocating of the long rigid power arms towards the electric motor end where reciprocating of the long rigid power arms is taking place during electricity generation, in this method it is attached individually, to three journal on the crankshaft by means of linear bearing & motion system. The linear bearings will be attached to a crankshaft journal saddle bearings and the linear shaft of the linear bearing as in FIG. 9 will be attached at the end of rigid power arm whereby upon rotation of the crankshaft by an external force, the long rigid power arms reciprocate. Each full rotations of crankshaft the three rigid power arms attached to the crankshaft will be respectfully 120 degrees apart and each arm is limited to an angular excursion ranging between 12 degrees and 40 degrees depending on the outer circumference of the crankshaft journal rotation. Thus turning the gearbox whereby the generator.

Second method is for larger generators as in FIG. 1 where the long rigid power arms are attached in similar manner as the first method. Where one end of the said long rigid power arm which is located on the generator side of the invention has two ratchet mechanism on each side of the long rigid power arm and a one way clutch in the middle of the said long rigid power arms. That is housed in a common shaft to turn the gearbox whereby generator. The long rigid power arms can be as long as required by design engineering to reduce torque. The other end of the long rigid power arm which is located at the electric motor side is ratchet, reciprocated and the degree of movement which is much wider in larger systems and therefore are individually guided, controlled the up and down movements by a separate upright conveyer type system in a large frame. The synchronized and uniformity movement is controlled by electric motor, gears, and transmission roller chains and micro processed to achieve the desired frequency 50 Hz or 60 Hz in this design.

The ratchet reciprocating of the long rigid power arm and uniformity is caused by three sets of upright conveyers individually framed as in FIG. 6-7 two set of transmission roller chains for each long rigid power arm. All sets of roller chains runs vertical on separate individual shafts and on identical size gears attached to the shaft at upper end supported by a independent frame which extends to the lower end of the said conveyer to support the conveyer structure, for each long rigid power arm and a pair of transmission roller chains, the lower end of the roller chains in pair of two are mounted on the said frame on two individual shafts and gears with each shaft mounted separately with gear for the transmission roller chain, each roller chain next to each other with four gears and two shafts are mounted to the frame with bearings, two for each said pair of transmission roller chains and a shaft, the other two gear is to attached to third shaft which is below the individual shafts with gears with each individual shaft. The difference between the individual said shafts and third shaft is that it's below the individual shafts and that it runs the full length of all individual shafts and whereby attaches to all of the reminding above gears on the lowest shaft, this shafts is turned by a separate electrical motor where the power is consumed which is generated by its own said generator, after been started by an external source of a much lower power than that the said generator is producing. As shown in drawings.

In present invention the external source of power can be fossil fuel driven engine to get the system in motion to producing power, immediately after the generator is producing full power as designed generator, a electric motor can take the place of the said fossil fuel motor to continue run the generator at on one third the cost of power produced by the said generator at the same time. That means, two third of the power produced by the generator can be used elsewhere, with zero consumption of fossil fuel after the initial start and zero emissions, this system of invention can continue to run until shutdown by disconnection of power to the electric motor.

Another method of reciprocating the three long rigid power arms towards the electric motor side of the invention is Ball screw assembly method on each arm separately and operated individually and synchronized by micro processor. This method would be best applied to a vertical design of the invention.

Yet another method of achieving the reciprocating of the long rigid power arms on the electrical motor side is RPS+RPG Mechanics drives for reciprocating motion and roller pinion system or gear and track system, all controlled by micro processor. This method would be best applied if the design of this invention is horizontal.

The advantage of a vertical system is, in the vertical system of the said invention is that the downward reciprocating torque at the electric motor end of the long rigid power arms can be further reduces by increasing the mass weight by up to 50% of the torque required to turn the generator, at the electrical motor end where the rigid power arms are connected to conveyer chains type system, this would increase the load to the electrical motor by additional load to lift but reduce the torque from the generator when arms are pulled down, the downwards motion reduces the torque because of gravity and the pull of the said additional weight thus further reducing the required torque to the motor to turn the generator.

This present invention can also be implemented on open sea as in FIG. 11 where a continues up and down movement of the long rigid power arms by the waves turns high torque required to turn the gearbox whereby the generator can generate electricity.

### BRIEF DESCRIPTION OF THE DRAWING

These and other features, aspects and advantages of the present invention will become better understood with regard to the following description, appended claims and accompanying drawings in which;

FIG. 1 a prospective view of the reciprocating of the long rigid power arms and low speed, high torque gearbox driven small power plant;

FIG. 2 a prospective view of the reciprocating of the long rigid power arms and low speed, high torque gearbox driven small power plant;

FIG. 3 is a diagrammatical representation of a small power generator;

FIG. 4 is an aerial perspective view of the a fully-assembled exemplary device for large generating electrical power plant in the exemplary embodiment of the present invention;

FIG. 5 depicts the small generator, gearbox and three set of ratchet mechanisms each which is housed with two ratchets and one way clutch bearing, to drive the shaft to the gearbox whereby generator;

FIG. 6 depicts of the top section conveyer type mechanism with transmission roller chains;

FIG. 7 depicts of the lower section of the conveyer type mechanism with transmission roller chains;

FIG. 8 is a diagrammatical representation of a small power generator;

FIG. 9 depicts a crankshaft type of the long rigid power arms reciprocating.

FIG. 10 depicts a linear bearing and motion system on the ratchet reciprocating arm at the gearbox and generator end on small generator;

FIG. 11 is aerial perspective view of ratchet reciprocating long rigid power arms on ocean surface powered continuously by waves.

### DETAILED DESCRIPTION OF THE PREFERRED EMBODIMENTS

The present invention relates to a low speed, high torque rotary drive which is particularly useful in conjunction with gearbox driven generators such as wind power generators, where high torque can be reduced with this device that is applied to the gearbox whereby to generate power. This process can also be implemented on automobiles, homes, small business and ocean surface to produce clean electricity at a reduced cost for multiple applications

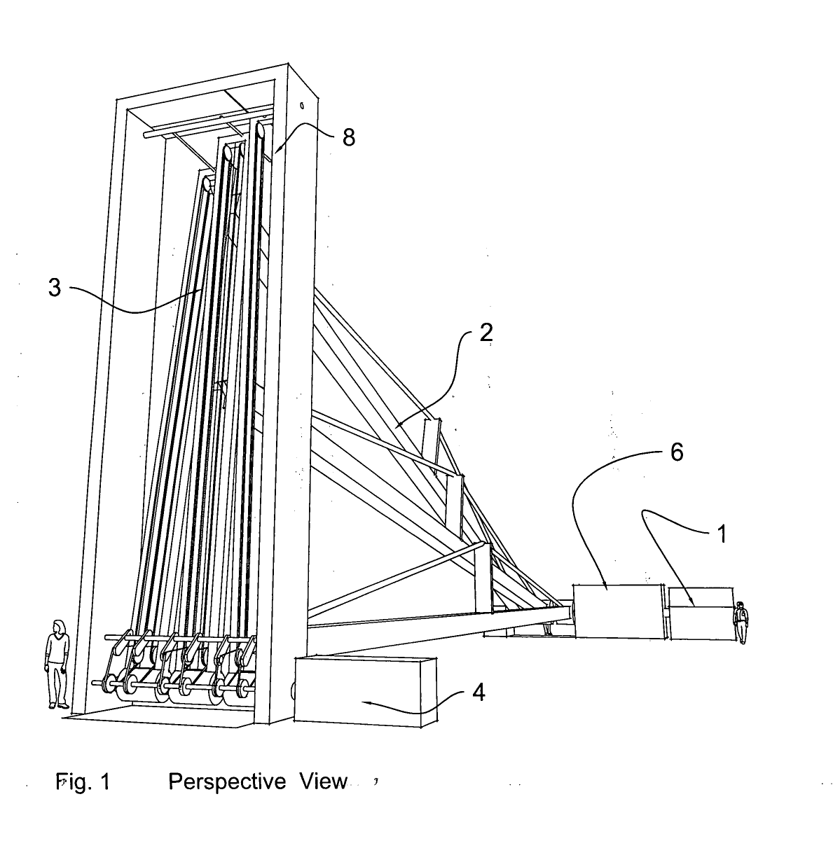

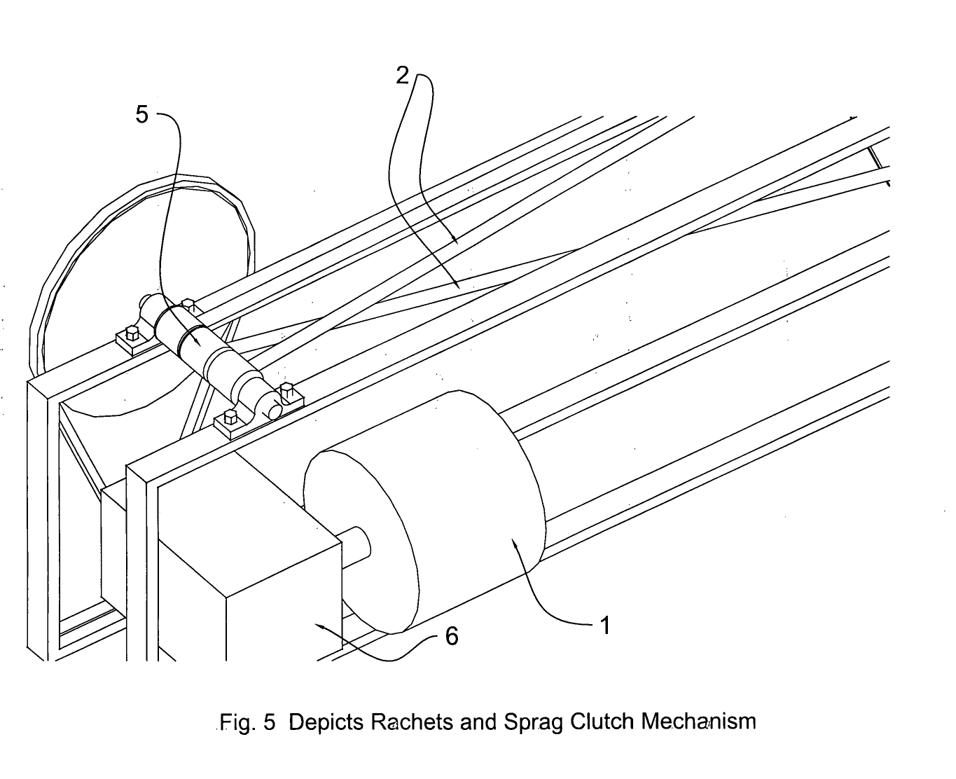

FIGS. 1-3, a perspective views thereof, an examples of generating power are using three or more long rigid power arms 2 been reciprocated with aid of a external motor 4 of a much reduced torque. The generator 1 is connected to a gearbox 6 to increase the torque and reduce the rpm at the input side of the gearbox 6 where the generator rpm will meet the designed requirement as shown in FIG. 5 there are three unit housed on a shaft, each unit has two ratchet mechanisms on both sides and the one way clutch bearing in the middle is housed as mentioned together, each unit is attached separately to the long rigid power arm for a positive action on the shaft. There are three units 5 on the shaft coupled to the input side the gearbox 6. The three long rigid power arms 2 is attached to the said individual housed units to turn the gearbox 6 shaft continuously as the long rigid power arms reciprocate to generate electricity for large power plant or small independent unit.

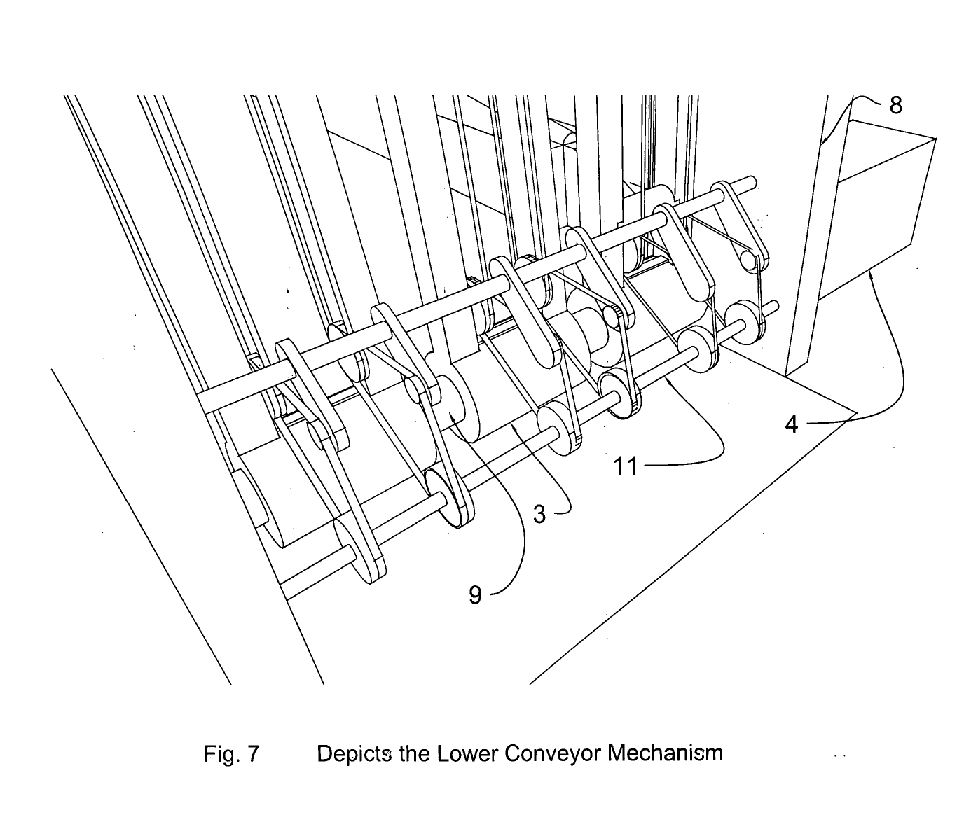

FIG. 1 of the drawings, in the perspective view of larger generator system, the motor 4 and the frame 8 is attached where frame 8 is the secured guiding structure of the three long power arms 2 in a uniform manner to reciprocate, by three sets of transmission roller chains on gears in three separate conveyer type system of three tall rectangular frames 3 inside the said secure guiding structure 8, side by side where all three conveyers are operating at same speed, along with the long rigid power arms attached to the conveyers transmission roller chains link, is space out evenly so that they reciprocate uniformly, two transmission roller chains and gears on two separate shafts as sets is operated independently in three separate tall rectangular unit 3, where the lower ends of this tall rectangular unit 3 is pivoted at 9 as in FIG. 7 on a common shaft all three of same size tall rectangular units 3 are reciprocating due to the radius of the long rigid power arms up and down movement causing the top of the tall rectangular unit 3 to lean forward and back. The top section where two transmission roller chains and gears are on two separate shafts, in line, on top and the bottom in the tall rectangular unit 3 and the two transmission roller chains as pairs are space apart so that the shaft that attaches one of the link on each chains so both roller chains with the shaft is to convey the attached linear bearing connecting rod on the long rigid power arm up and down and in-between the two gears on top and the bottom continuously, as the tall rectangular unit 3 is moving back and forth due to the radius of the long rigid arms this allowing the three long rigid arms 2 to reciprocate, additional one transmission roller chain and gear FIG. 7 of the same size is attached to the two lower shaft and gears 11 of each rectangular unit 3 to a common shaft that is powered by a motor and gearbox 4 as required by design to meet the required torque to turn the conveyer.

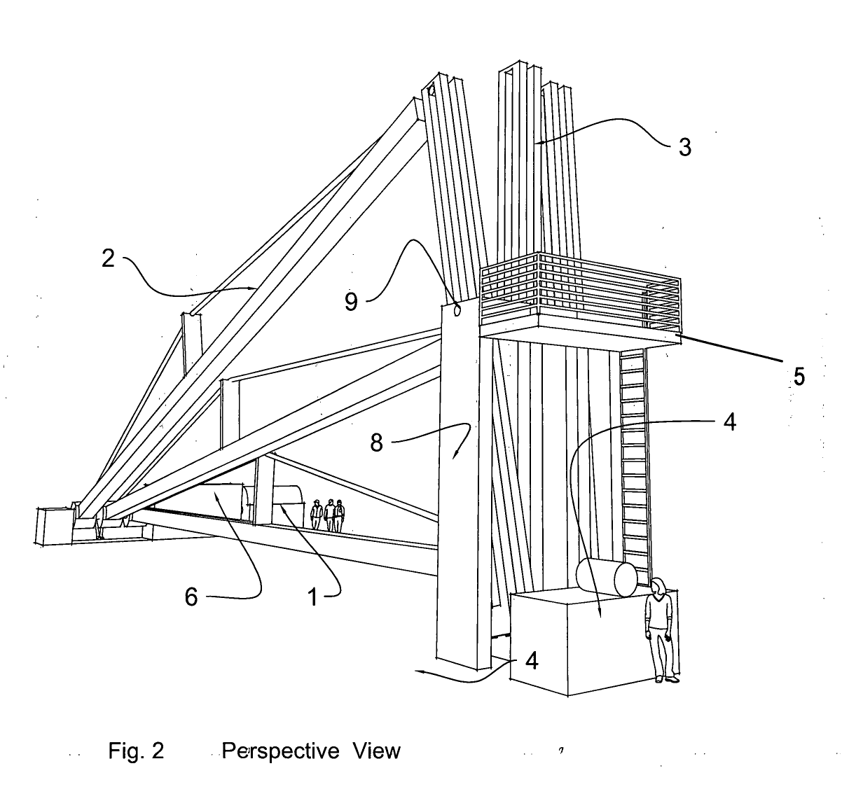

FIG. 2 is a perspective view similar device to FIG. 1 except that the reciprocating action of the three long rigid power arms 2 in FIG. 2 that turns the gearbox 6 whereby the generator 1 is where they differ. The apparent difference is the tall rectangular frames 3 that housed in 8, the entire conveyer mechanism to reciprocate the long rigid power arm 2 is pivoted 9 in the center of the all three tall rectangular units 3 and where the bottom and the top of the tall rectangular units 3 are moving in and out, the center that is pivoted 9 by the outer radius and the up and down movement of the three long rigid power arms which is secured by frame 8 The motor 4 can be located on the ground or on the walkway 5. as per design.

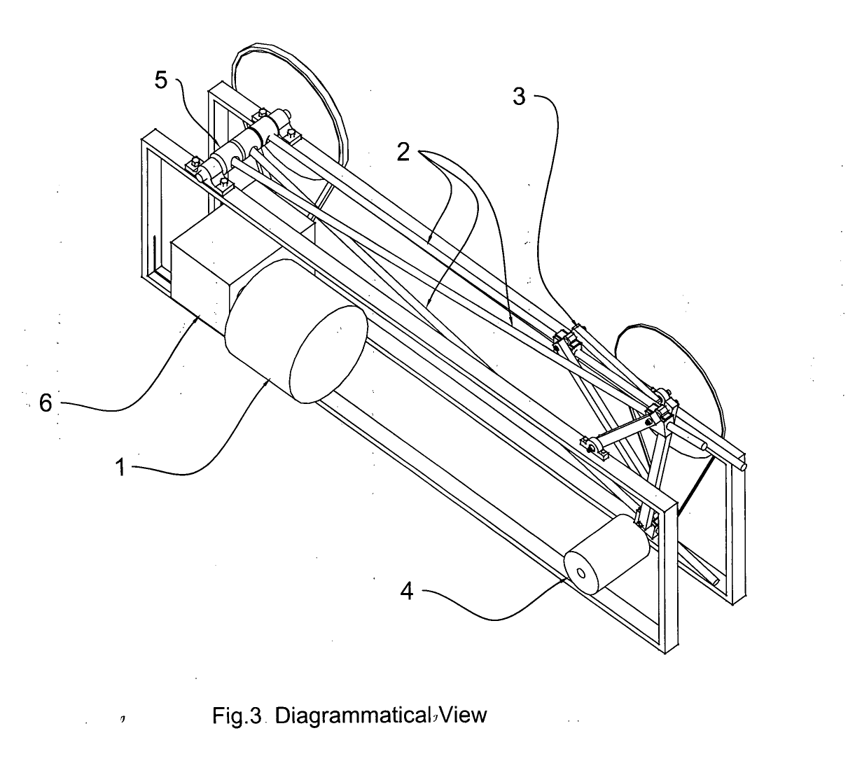

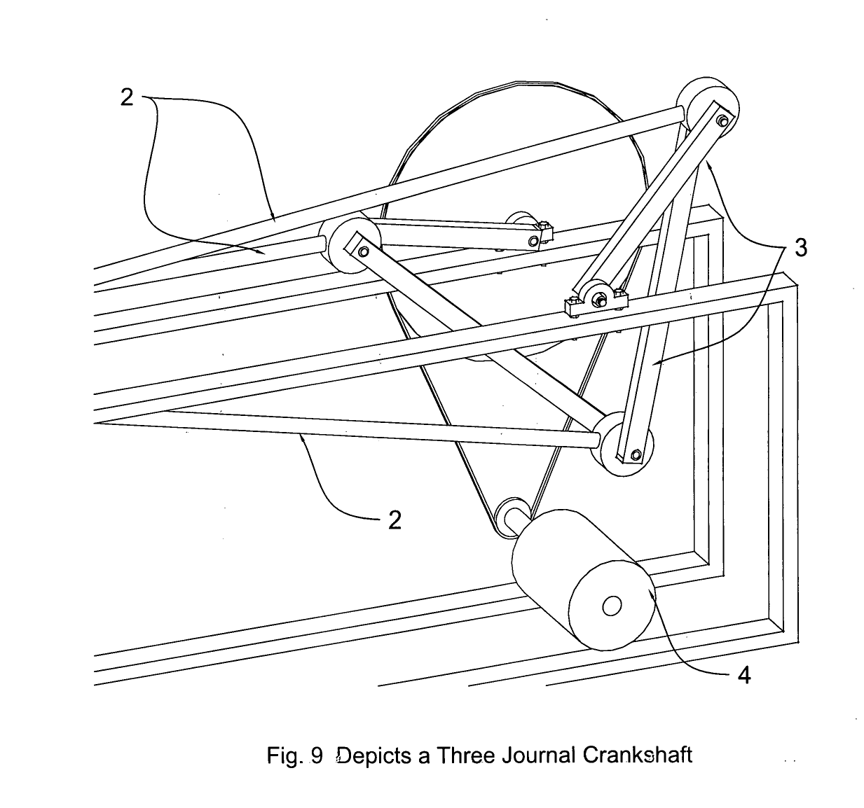

FIG. 3 is a perspective view of device of a smaller, lower capacity generating device is mounted on a frame where the three long ratchet reciprocating arms 2 on generator 1 side of the device are mounted pillow block on a shaft with three unit that are housed with two ratchet mechanism and a one way clutch bearing in the middle of said housing 5 which is attached to each of the long rigid power arms 2 separately to facilitate the continuous rotation of the gearbox 6 whereby the generator, the other end of the long rigid power arms 2 that are reciprocated by a crankshaft in FIG. 9 where the crankshaft journal is connected to the long rigid power arms by a linear bearing and motion system which facilitates long rigid power arm to sides on the crankshaft as the crankshaft rotates with an aid of a motor 4. This rotation on the crankshaft 3 is initially powered by a external power source to get the said invention in motion to produce the designed capacity, soon after the system is fully operational the external power is cut off and the power generated by the said generator is consumed, to continue the generation at about a third of the power produced continuously.

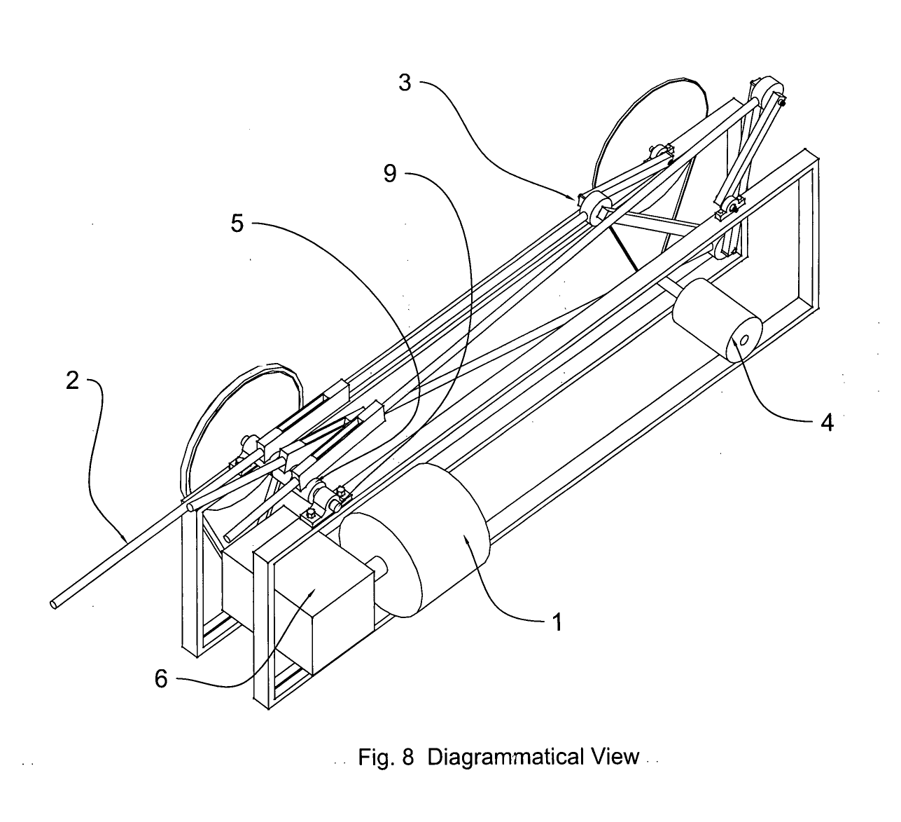

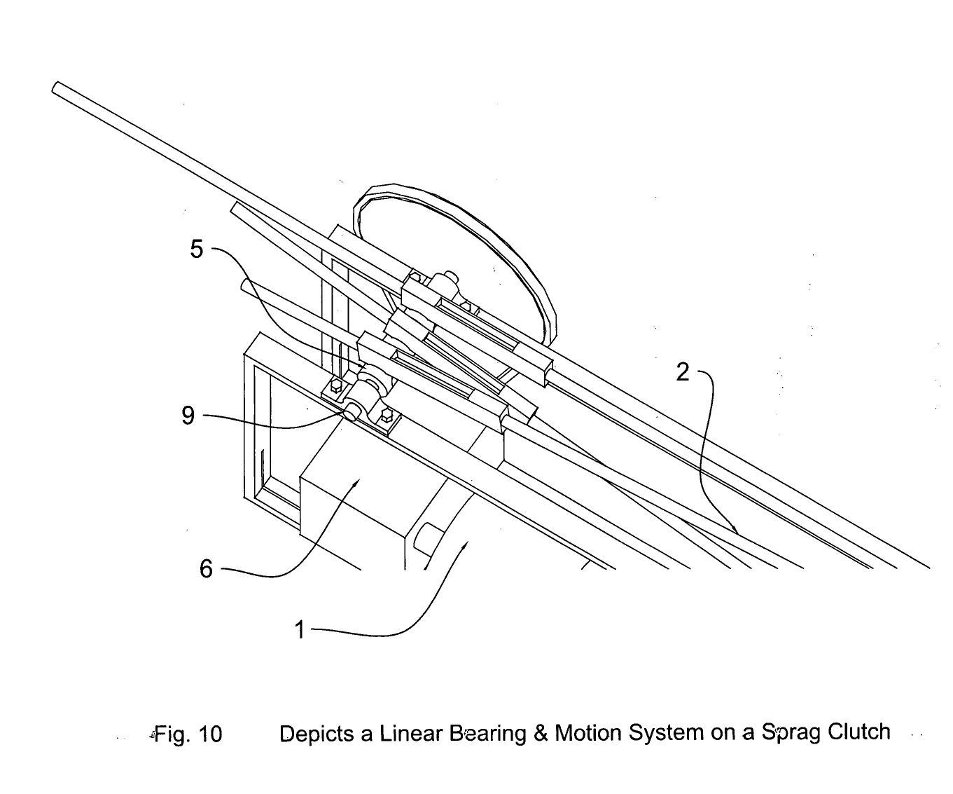

FIG. 8 is similar to FIG. 3 except that the long rigid power arms 2 are sliding on the housed units 5 of the ratchet mechanisms in FIG. 10 with linear bearing and motion system, where the long rigid power arms 2 is sliding on the said housed units rocking the housed unit causing a ratcheting, reciprocating motion on each independently causing the three housed unit to turn gearbox 6 continuously whereby the generator 1. The other end of the long rigid power arms are connected to a crankshaft directly to a crankshaft journal as in FIG. 9

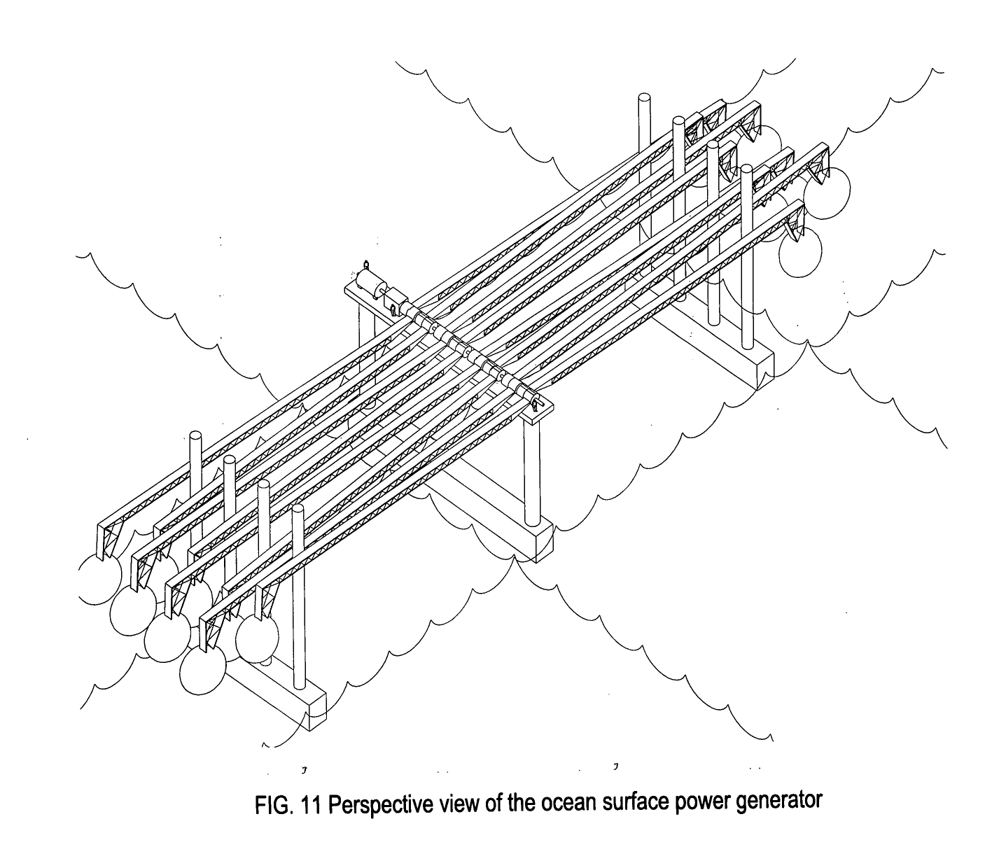

FIG. 11 illustrates that the long rigid arms and a ratcheting, reciprocating motion can be implemented on the ocean surface to generate energy on a large scale.

By virtue of the instant invention, there is provided a device more realistically reduce our dependency on natural resource energy and reduce pollution. Additionally hydrogen can be generated with the generated energy which can be used in vehicles as well utility demands.

### ILLUSTRATIVE EMBODIMENTS

Although this invention has been described in certain specific embodiments, many additional modifications and variations would be apparent to those skilled in the art. It is, therefore, to be understood that this invention may be practiced otherwise than as specifically described. Moreover, to those skill in the various arts, the invention itself herein will suggest solutions to other tasks and adaptations for other applications. Thus, the embodiments of the invention described herein should be considered in all respects as illustrative and nor restrictive, the scope of the invention to determined by the appended claims and their equivalent rather than foregoing description.

What is claimed is:

1. A device for generating electricity at low speed, high torque gearbox driven generator, which comprises of three or more long rigid high torque ratcheting and reciprocating arms by a motor or an external power source that requires a third of torque than that is required by the generator, as in FIG. 1 for larger units and FIG. 3 for smaller ones, more importantly to turn the said gearbox and the generator to maintain the required speed to meet the frequency of 50 Hz or 60 Hz as desired and to generate electricity as a small power plant of AC power.

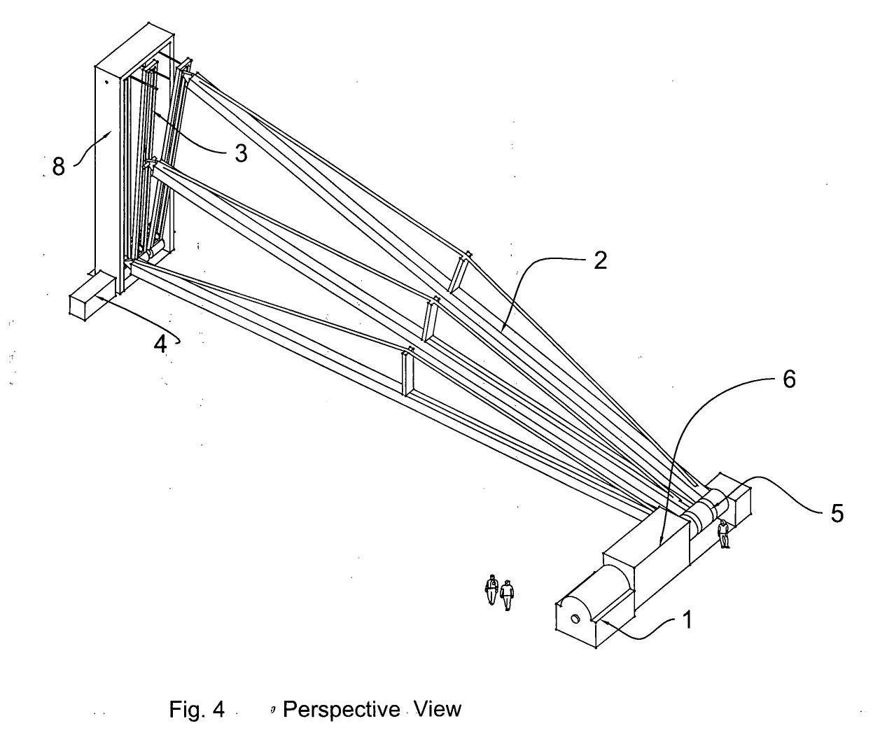

2. A device for generating electricity at low speed, high torque gearbox driven generator, which comprises of three or more long rigid high torque ratcheting and reciprocating arms according to claim 1 the arms, one end of all three arms on the generator side of the invention and are attached to a common shaft which couples to the gearbox, each arm has two ratchet mechanisms on both sides of each arm and a one way clutch bearing sandwiched in-between ratchet mechanisms on the said shaft housed individually as pivotable through an arc on movement of the long rigid power arms between its raised and lowered position separately so as to cause continues rotation on the input drive of the gearbox in response to movement of the long rigid power arms to turn the generator as in FIG. 4 where there is a enormous torque to overcome.

3. A device for generating electricity at low speed, high torque gearbox driven generator, which comprises of three or more long rigid high torque ratcheting and reciprocating arms according to claim 1 the other end of said three long rigid power arms on motor side is reciprocated, this reciprocating is caused by ratchet motion of the long rigid power arms, the ratcheting and reciprocating action is achieved by a separate device which is powered by a motor causing the up and down movement of the long rigid power arms as in the drawings is accomplished by several methods.

4. A device for generating electricity at low speed, high torque gearbox driven generator, which comprises of three or more long rigid high torque ratcheting and reciprocating arms according to claim 1 this entire invention can also be place horizontal and the reciprocating movement of the long rigid power arms would be from side to side by placing the entire invention from a vertical position to a horizontal position to achieve the same results as per design.

5. A device for generating electricity at low speed, high torque gearbox driven generator, which comprises of three or more long rigid high torque ratcheting and reciprocating arms according to claim 1 one end of the long rigid power arms that are attached to shafts on the generator side for a positive action on the part of the ratchet mechanisms and the one way clutch bearings to turn the high torque gearbox whereby the generator, can be turned clockwise for positive action as well counter clockwise for positive action as desired by design.

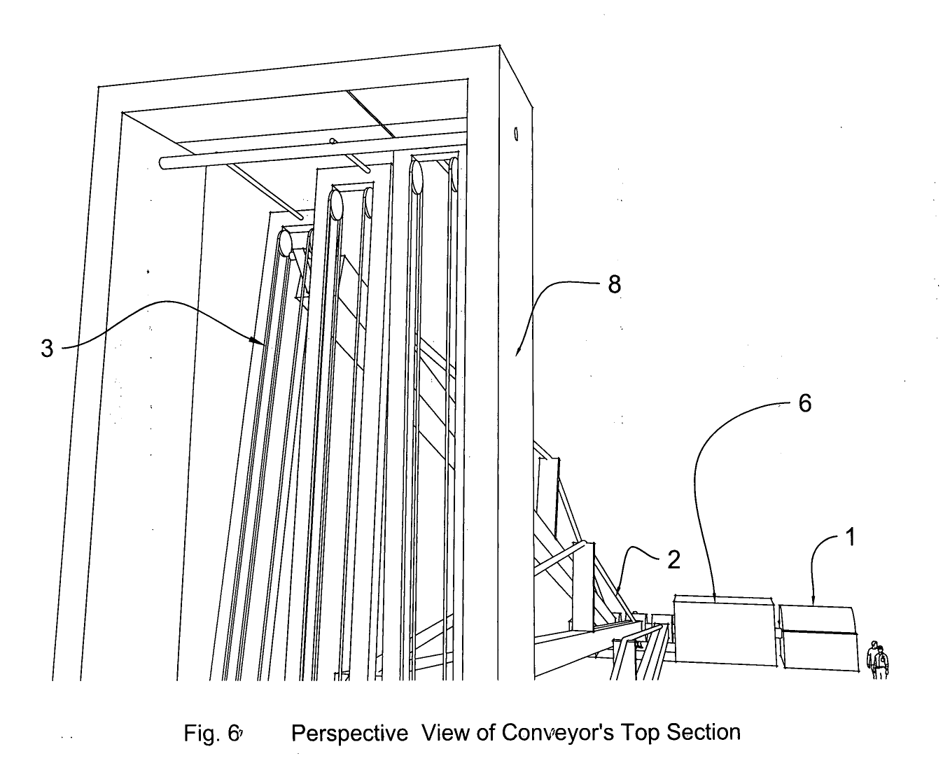

6. A device for generating electricity at low speed, high torque gearbox driven generator, which comprises of three or more long rigid high torque ratcheting and reciprocating arms according to claim 3 the motor side of the reciprocating long rigid power arms in this invention can be reciprocated in several way as claimed;
the first consisting of crankshaft type of a design as in FIG. 9 where the arms are attached to three journals on the crankshaft by means of linear bearing and motion system, or attached in a form of a connecting rod on the crankshaft journal as in FIGS. 8 and 10 the other end of the rigid arms on the generator side of the invention, are the arms sliding on linear bearing and motion housing tuning the high torque shaft to the desired rpm by design where the crankshaft can be tuned by an external source for small generators;
the second consisting for larger generators, as in FIGS. 6 and 7 double transmission roller chain link driven parallel on the conveyer type system where a gear and shaft is attached between the two said roller transmission chains that are running parallel in the tall rectangular frame 3 where each long rigid arm is attached in form of a connecting rod and a linear motion bearing system to the shaft on the transmission roller chain link, evenly spaced out the three sets of transmission roller chains, gear and shafts for three long rigid power arms to maintain a uniform movement of the arms. The lower ends of the parallel pairs of transmission roller chains are mounted on three separate shafts with two gears on each shaft of which one gear is attached to a chains conveying the connecting rod on the long rigid power arm been reciprocated, the other gear to the shaft below of the said two shafts. The lowest shaft runs the entire length of the three sets of frames as in FIG. 7 this said lowest shaft is turned by a gearbox and a motor to generate electricity;
the third method consisting of ball screw assemblies type of a system is where a ball screw is the entire length of the, reciprocating arm's travel distance and is mounted on two bearing, one on the top and one at the bottom in a frame, the long rigid arm is connected to a nut housing or carriage element, where the ball screw shaft turns and motion takes place of the reciprocating arm, this method is applied to all three long rigid arms and where the all three ball screw are turned by an external electrical motor controlled by a microchip processor. The lower part of the three ball screws and bearing are in individually housed unit and are mounted on a common bearing shaft, where ball screw are held in separate frames and are pivoted as each rigid arm reciprocate on rigid arm's outer radius and the ball screw is upright and housed in a frame where the frame on the top moves a very short travel distance back and forth, as the bottom is held in place as the ball screw shaft is turned. This method can be applied to a vertical and horizontal design of this invention;
the forth consisting of RPS+RPG Mechanics Linear drive reciprocating motion that is motion is on a roller pinion and rack system to reciprocate the long rigid power arms, this method is applied to a horizontal design of this invention where the long rigid power arms swings from side to side;
the fifth method consisting of is large three or more cam lobes on a camshaft rotated by the motor where the long rigid power arms are reciprocated on the cam, can be implemented in this invention for small generators;
the sixth method consisting of a large generator unit as in FIG. 2 that is similar to FIG. 1 except the double transmission roller chain link driven parallel on the conveyer type system is that the entire long rectangular frame 3 is not pivoted 9 at the bottom but in the middle where the entire conveyer control mechanism is placed, and a walkway.

7. A device for generating electricity at low speed, high torque gearbox driven generator, which comprises of three or more long rigid high torque ratcheting and reciprocating arms according to claim 1, in the vertical system of the said invention is that the downward reciprocating torque at the electric motor end of the long rigid power arms can be further reduces by increasing the mass weight by up to 50% of the torque required to turn the generator, at the electrical motor end where the rigid power arms are connected on conveyer transmission roller chains type system, this would increase the load to the electrical motor by adding the additional load to lift but reduce the torque from the generator when arms are coming down, the downwards motion reduces the torque because of gravity and the pull of the said additional weight thus further reducing the required torque to the motor to turn the generator.

8. A device for generating electricity at low speed, high torque gearbox driven generator, which comprises of three or more long rigid high torque ratcheting and reciprocating arms according to claim 1 can be installed on the sea surface as in FIG. 11 where waves would reciprocate the long rigid power arms continuously that would turn the gearbox whereby the generator.
